(19) United States
(12) Patent Application Publication
(10) Pub. No.: US 2007/0171502 A1
(43) Pub. Date: Jul. 26, 2007

(54) Beam deflector and scanning microscope

(75) Inventors: Holger Birk, Meckesheim (DE); Dirk-Oliver Fehrer, Oftersheim (DE); Michael Goldner, Mannheim (DE)

Correspondence Address: HOUSTON ELISEEVA, 4 MILITIA DRIVE, SUITE 4, LEXINGTON, MA, 02421, US

(73) Assignee: Leica Microsystems CMS GmbH, Wetzlar (DE)

(21) Appl. No.: 11/252,971

(22) Filed: Oct. 18, 2005

(30) Foreign Application Priority Data
Oct. 19, 2004 (DE) DE 10 2004 049 43

(51) Int. Cl. G02B 26/08

(52) U.S. Cl. 359/225

(57) ABSTRACT

A scanning microscope comprises a beam deflector with at least one movable deflector to adjust the deflection of a light beam. The scanning microscope is characterized in that the movable deflector is positioned in a largely soundproof housing with one entrance window and/or one exit window.

### RELATED APPLICATIONS

This application claims priority to German patent application number DE 10 2004 049 437.1, filed Oct. 19, 2004, which is incorporated herein by reference in its entirety.

### BACKGROUND OF THE INVENTION

The invention relates to a beam deflector with at least one movable means of deflection to adjust the deflection of a light beam.

The invention further relates to a scanning microscope with at least one movable means of deflection to adjust the deflection of a light beam.

### SUMMARY OF THE INVENTION

In scanning microscopy, a sample is illuminated with a light beam to observe the reflection and fluorescent light emitted by the sample. The focus of an illumination light beam is moved in an object plane with the help of a maneuverable beam deflector, generally by tipping two mirrors, whereby the axes of deflection are usually positioned perpendicular to each other, so that one mirror deflects in the x-direction and the other in the y-direction. The mirrors are tipped with the help, for example, of galvanometric positioners. The power of the light coming from the object is measured dependent on the position of the scanning beam. Generally, the positioners are provided with sensors to determine the actual position of the mirrors.

In confocal scanning microscopy in particular, an object is scanned in three dimensions with the focus of a light beam.

A confocal scanning microscope generally comprises a light source, a focusing optic with which the light from the source is focused on a pinhole aperture—the so-called excitation aperture—, a beam splitter, a beam deflector to control the beam, a microscope optic, a detection aperture, and detectors to detect the detection light or fluorescent light. The illumination light is often coupled via the beam splitter which, for example, may be implemented as a neutral beam splitter or as a dichroic beam splitter. Neutral beam splitters have the disadvantage that a great deal of excitation light or detection light is lost, depending upon the splitting ratio.

The fluorescent light or reflection light coming from the object returns to the beam splitter via the beam deflector, passes through it, and finally focuses on the detection aperture, behind which are the detectors. Detection light that does not originate directly from the focal region takes another light path and does not pass through the detection aperture, so that pixel information is obtained that leads to a three-dimensional image as a result of sequential scanning of the object. In most cases, a three-dimensional image is achieved by layered data imaging, whereby the path of the scanning light beam ideally describes a meander on or in the object. (Scanning a line in the x-direction at a constant y-position, then interrupting x-scanning and y-repositioning to the next line to be scanned, and then scanning this line at a constant y-position in negative x-direction, etc.). To enable layered data imaging, the sample table or the objective is repositioned after scanning a layer so that the next layer to be scanned is brought into the focal plane of the objective.

A variety of beam deflectors are known in scanning microscopy to direct an illumination light beam over or through a sample. One example is DE 196 54 210 C2, which describes an arrangement for scanning a beam in two axes that lie largely perpendicular to each other.

Galvanometric mirrors in particular are used in many areas of optics for fast deflection of light beams. For example, in scanning microscopy, scanning light beams are directed over a sample with the help of mirror arrangements that are galvanometrically driven. Resonant galvanometers that allow a mirror to rotate around an axis at a frequency of several kHz are often used to achieve high scanning rates.

A disadvantage is that the known beam deflectors whistle loudly and unpleasantly, particularly at high deflection rates.

It is therefore the object of the present invention to disclose a beam deflector with at least minimized noise.

This object is solved by a beam deflector wherein the movable deflector is positioned in a largely soundproof housing with one entrance window and/or one exit window.

A further object of the present invention is to disclose a scanning microscope with at least less significant noise.

The further object is solved by a scanning microscope, wherein the movable deflector is positioned in a largely soundproof housing with one entrance window and/or one exit window.

The invention has the particular advantage that significant noise reduction is achieved by encapsulating the deflector. For this purpose, the entrance window and/or the exit window of the housing in a particularly preferred embodiment may comprise optical components that are required in any case in the overall optical construct in which the beam deflection is implemented.

Preferably, the entrance window and/or the exit window contains one optical element that is at least partially transparent. The entrance window and/or the exit window can, for example, comprise one or several lenses and/or one or several beam splitters and/or one or several filters.

In a particularly preferred embodiment of the scanning microscope according to the invention, the entrance window and/or the exit window comprises the scanning lens, the tube lens, and/or a beam expansion optic of the scanning microscope. In this embodiment, there are no additional optical components in the beam path so that there is no additional loss of illumination light or detection light, nor unwanted interference.

In a preferred embodiment of the invention, the deflector comprises a swing mirror that can, for example, be designed as a galvanometric mirror. It is particularly advantageous for the beam deflector according to the invention or the scanning microscope according to the invention when resonant swing deflectors—particularly resonant galvanometric mirrors—are used.

In one embodiment, the deflector comprises a rotating mirror, in particular a polygonal mirror.

In a particularly preferred embodiment of the invention the housing is lined with a sound-absorbing material. This can, for example, consist of a foam material. The lining preferably exhibits a naps or tips.

Preferably, means for preventing the transfer of structural noise from the housing to the rest of the scanning microscope are provided. For this purpose, the housing can, for example, be elastically mounted. It is also possible to apply blanket insulation to the suspension mounts of the housing.

The scanning microscope is preferably implemented as a confocal scanning microscope.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

The object of the invention is schematically depicted in the diagram and will be described on the basis of figures below, whereby components that function in the same manner have the same reference numbers. Shown is:

FIG. 1 A scanning microscope according to the invention with a beam deflector according to the invention.

### DETAILED DESCRIPTION OF THE PREFERRED EMBODIMENTS

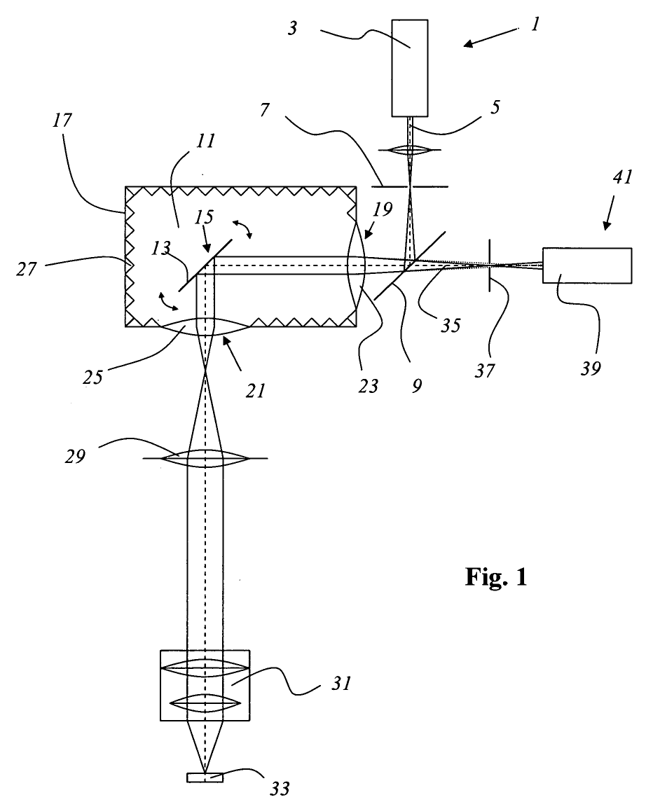

FIG. 1 shows a scanning microscope according to the invention that is implemented as a confocal scanning microscope. The scanning microscope exhibits a first illumination light source 1 that is implemented as a multiline laser 3 and that generates an illumination light beam 5. The illumination light beam 5 passes through the illumination pinhole aperture 7 and is subsequently directed via a primary beam splitter 9 that is implemented as a dichroic filter to a beam deflector 11 that comprises a cardanically mounted scanning mirror 13 as the movable deflector 15.

The beam deflector 13 exhibits a soundproof housing 17 in which is arranged the movable deflector 15 for adjustable deflection of the illumination light beam 5. The soundproof housing 17 exhibits an entrance window 19 and an exit window 21 in relation to the illumination light beam 5. The entrance window 19 is implemented as a lens 23 that collimates the illumination light beam 5. The exit window 21 comprises the scanning lens 25 of the scanning microscope. The housing 17 is lined with a sound-absorbing material 27, in particular a foam fleece napping.

The beam deflector 11 directs the illumination light beam 5 through the scanning lens 25, the tube optic 29 as well as through the objective 31 or through the sample 33, respectively. The detection light 35 emitted by the sample 33 (e.g., reflection light, fluorescent light) travels along the same light path, namely through the objective 31, the tube optic 29 as well as through the scanning lens 25 back to the cardanically mounted scanning mirror 13 that deflects the detection light 35 to the primary beam splitter 9. The detection light 35 passes the primary beam splitter 9 and the subsequent detection pinhole aperture 37 and finally reaches a detector 39 that is implemented as a photomultiplier 41.

The invention was described in relation to a particular embodiment. However, it is clear that changes and variations can be implemented without abandoning the scope of the following claims.

Reference list:

1-Illumination light source; 3-Multiline laser; 5-Illumination light beam; 7-Illumination pinhole aperture; 9-Primary beam splitter; 11-Beam deflector; 13-Scanning mirror; 15-Movable deflector; 17-Housing; 19-Entrance window; 21-Exit window; 23-Lens; 25-Scanning lens; 27-Sound-absorbing material; 29-Tube optic; 31-Objective; 33-Sample; 35-Detection light; 37-Detection pinhole aperture; 39-Detector; 41-Photomultiplier.

While this invention has been particularly shown and described with references to preferred embodiments thereof, it will be understood by those skilled in the art that various changes in form and details may be made therein without departing from the scope of the invention encompassed by the appended claims.

What is claimed is:

1. Beam deflector with at least one movable deflector to adjust the deflection of a light beam, wherein the movable deflector is positioned in a largely soundproof housing with one entrance window and/or one exit window.

2. Beam deflector according to claim 1, wherein the deflector comprises a swing mirror.

3. Beam deflector according to claim 1, wherein the deflector comprises a galvanometric mirror.

4. Beam deflector according to claim 3, wherein the deflector comprises a resonant galvanometric mirror.

5. Beam deflector according to claim 1, wherein the deflector comprises a rotating mirror, in particular, a polygonal mirror.

6. Beam deflector according to claim 1, wherein the entrance window and/or the exit window comprises an optical element that is at least partially transparent.

7. Beam deflector according to claim 6, wherein the entrance window and/or the exit window comprise at least one lens, or at least one beam splitter, or at least one optical filter.

8. Beam deflector according to claim 1, wherein the housing is lined with a sound-absorbing material.

9. Scanning microscope with a beam deflector with at least one movable deflector to adjust the deflection of a light beam, wherein the movable deflector is positioned in a largely soundproof housing with one entrance window and/or one exit window.

10. Scanning microscope according to claim 9, wherein the deflector comprises a swing mirror.

11. Scanning microscope according to claim 9, wherein the deflector comprises a galvanometric mirror.

12. Scanning microscope according to claim 11, wherein the deflector comprises a resonant galvanometric mirror.

13. Scanning microscope according to claim 9, wherein the deflector comprises a rotating mirror, in particular a polygonal mirror.

14. Scanning microscope according to claim 9, wherein the entrance window and/or the exit window comprises an optical element that is at least partially transparent.

15. Scanning microscope according to 14, wherein the entrance window and/or the exit window comprises at least one lens or at least one beam splitter, or at least one optical filter or the scanning lens and/or the tube lens of the scanning microscope or a beam expansion optic.

16. Scanning microscope according to claim 9, wherein the housing is lined with a sound-absorbing material.

17. Scanning microscope according to claim 9, wherein the scanning microscope is a confocal scanning microscope.
